(19) United States
(12) Patent Application Publication
(10) Pub. No.: US 2009/0079310 A1
(43) Pub. Date: Mar. 26, 2009

(54) WORK BENCH AND WORK BENCH ASSEMBLY

(76) Inventor: Paul Andrew Sparrow, Weymouth (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/095,495

(22) PCT Filed: Nov. 30, 2006
(86) PCT No.: PCT/GB2006/004473

§ 371 Date: Nov. 18, 2008

(30) Foreign Application Priority Data
Nov. 30, 2005 (GB) 0524383.7

(51) Int. Cl. A47B 88/00; A47B 46/00; B23Q 3/00

(52) U.S. Cl. 312/330.1; 312/249.1; 269/296

(57) ABSTRACT

A work bench module, (A, B, C, D) comprises a planar work surface (11), a storage (7, 9) space being defined in the module (A, B, C, D) below the work surface, equipment mounting means (15) being provided on which a piece of equipment (13, 19, 20) can be mounted in use, the equipment mounting means being itself mounted on the module (A, B, C, D) so as to be moveable from a retracted position in which the piece of equipment is stored in the storage cavity to an operative position in which the piece of equipment can be accessed from the exterior of the module (A, B, C, D). A work bench assembly comprising a plurality of work bench modules is also provided.

The present invention relates to a work bench and work bench assembly and particularly but not exclusively relates to a work bench and work bench assembly for mounting in a vehicle.

A mobile tradesperson transports and/or stores their tools and equipment in a vehicle such as a van. The load space of such vans is often not particularly well organised and it can be difficult to safely use and/or store pieces of equipment in such a confined space. Consequently such equipment is often dumped on the floor of the vehicle with tools and other equipment on top. It can then be relatively difficult to find such equipment when needed, and the equipment is susceptible to damage. Such problems can also arise in other relatively confined spaces such as a garage or shed for example.

According to a first aspect of the invention there is provided a work bench module, the module comprising a planar work surface, a storage space being defined in the module below the work surface, equipment mounting means being provided on which a piece of equipment can be mounted in use, the equipment mounting means being itself mounted on the module so as to be moveable from a retracted position in which the piece of equipment is stored in the storage cavity to an operative position in which the piece of equipment can be accessed from the exterior of the module.

The piece of equipment may comprise any desired piece of equipment including, for example, a power tool or bench mount type tool, hand held tools, kitchen or camping equipment, and/or storage enclosures such as a tool box.

The mounting means may be slidably mounted on the module to enable the piece of equipment to slide from the retracted position to the operative position.

Preferably the mounting means comprises a carriage on which the piece of equipment is mounted in use, the carriage being movably mounted on at least one guide rail provided on the module.

The mounting means may be pivotally mounted on the module to enable the piece of equipment to pivot from the retracted position to the operative position.

Preferably the mounting means comprises support means to support the piece of equipment in the operative position.

Preferably the support means comprises a gas filled strut. Preferably the gas filled strut is lockable so that, when locked, the length of the strut is non-adjustable.

Preferably the work bench module comprises a retractable work table movable from a retracted, substantially vertical position to an operative, substantially horizontal position.

Preferably the retractable work table is removably mounted on a support, the support being mounted on the work bench module, the work table, when removed from the support, being free standing.

Preferably the mounting means comprises means to enable the piece of equipment to be releasably mounted on the mounting means, and means to enable the mounting means to be releasably mounted on the work bench module.

Preferably the mounting means is adapted so as to be mounted on the work bench module to enable the piece of equipment to be moved relative to the work bench module when the piece of equipment is in the operative position.

Preferably the mounting means comprises a mounting device removably mounted on a bar on the work bench module such that a piece of equipment mounted on the device is movable in a direction along the bar.

Preferably part of the mounting device is mounted on the bar, another part being supported in use on an opposed guide surface on the work bench module.

Preferably the guide surface comprises part of a slot provided on the work bench module.

Preferably the mounting device comprises a rod that extends between the bar and the guide surface when the device is mounted on the work bench module, the piece of equipment being removably mounted on the device in use.

According to a second aspect of the invention there is provided a work bench assembly comprising a plurality of work bench modules, at least one of the modules comprising a planar work surface, a storage space being defined in the module below the work surface, equipment mounting means being provided on which a piece of equipment can be mounted, the equipment mounting means being itself mounted on the module so as to be moveable from a retracted position in which the piece of equipment is stored in the storage cavity to an operative position in which the piece of equipment can be accessed from the exterior of the module.

According to a third aspect of the invention there is provided a mounting device for mounting a piece of equipment on a work bench, the device comprising means to removably mount the device on the work bench, and means to removably mount the piece of equipment on the device comprising a rod, the piece of equipment being removably mounted on the rod in use.

Preferably the support means comprise bracket means that enable the rod to be supported by and movable relative to the work bench.

Preferably the means to mount the piece of equipment on the rod, and the means to mount the device on the workbench are arranged such that the device can be moved in one direction relative to the work bench and the piece of equipment can be moved in a perpendicular direction relative to the work bench.

Other aspects of the present invention may include any combination of the features or limitations referred to herein.

The present invention may be carried into practice in various ways, but embodiments will now be described by way of example only with reference to the accompanying drawings in which:

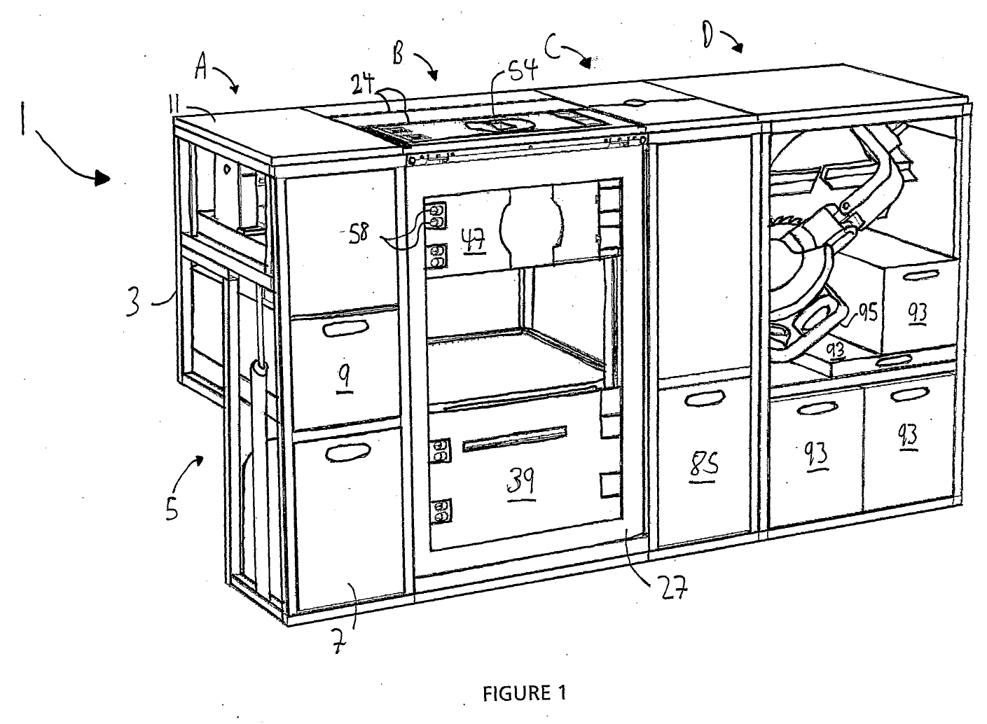

FIG. 1 is a perspective view from the front of a modular work bench assembly in accordance with the present invention, with parts of the assembly in a stored position;

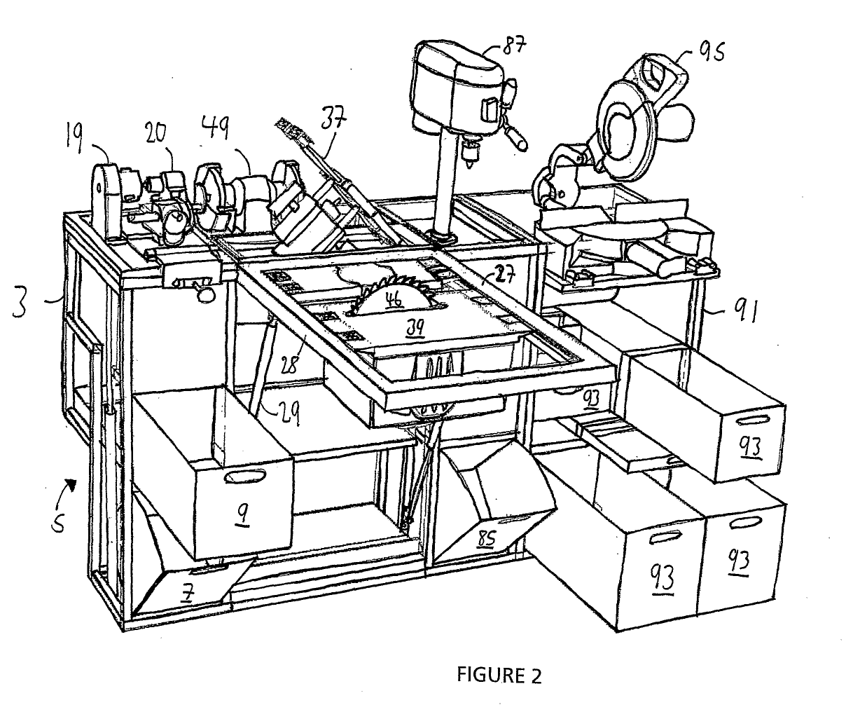

FIG. 2 is a perspective view from the front of the work bench assembly of FIG. 1 with parts of the assembly in a operative position;

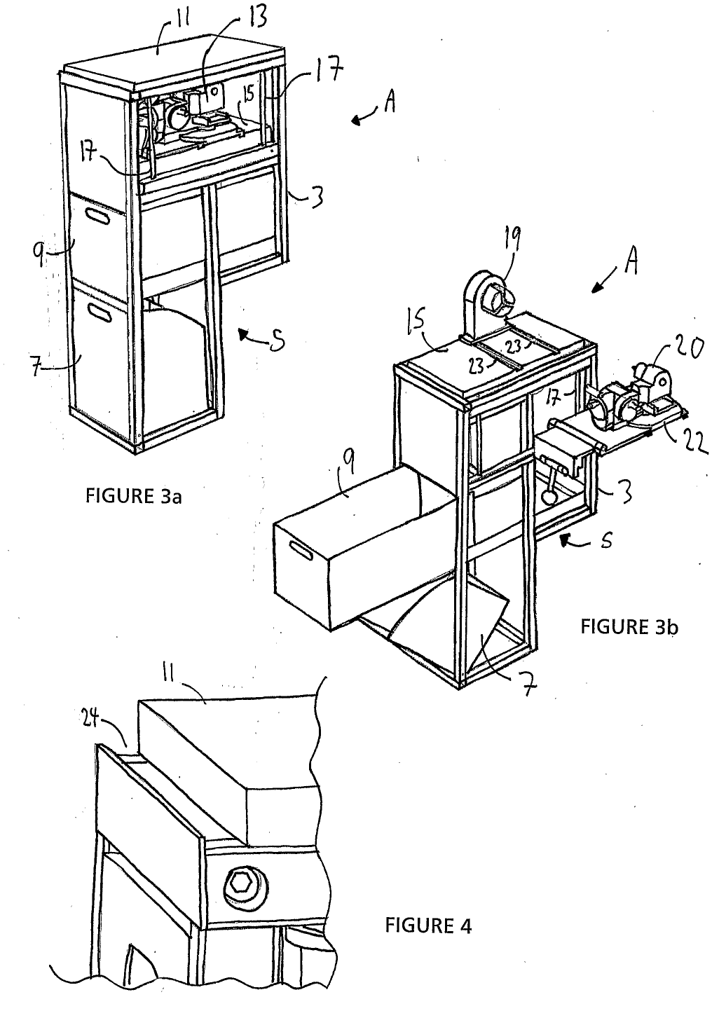

FIGS. 3a and 3b are perspective views from the front and one side of a first module of the work bench assembly of FIGS. 1 and 2, showing parts of the module in stored and operative positions respectively;

FIG. 4 is an enlarged perspective view of an upper corner of the module of FIG. 3;

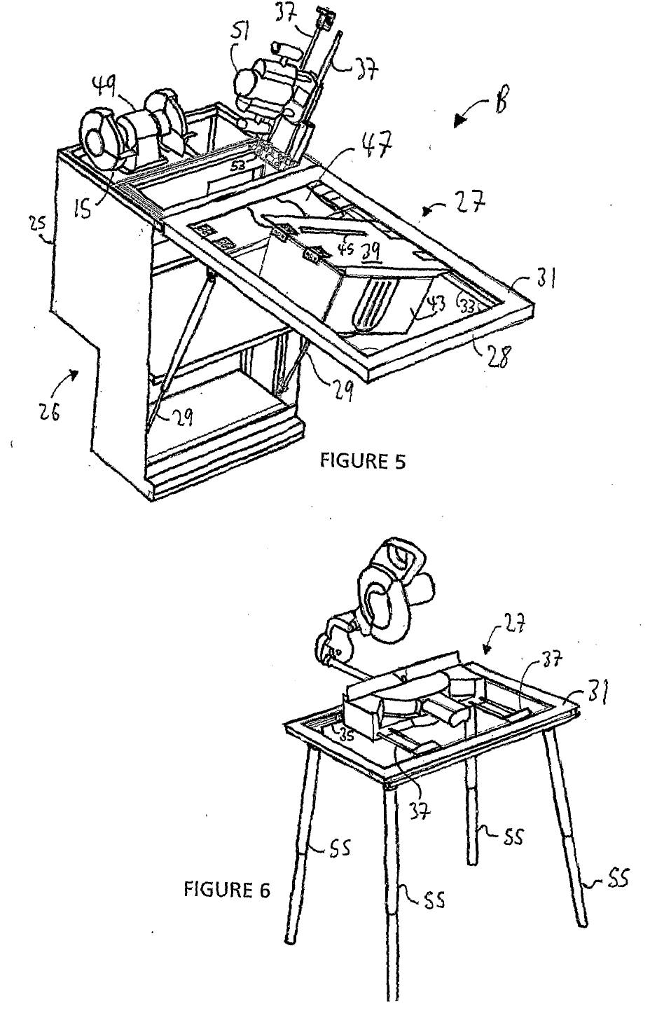

FIG. 5 is a perspective view from the front and one side of a second module of the work bench assembly of FIGS. 1 and 2, showing parts of the module in an operative position;

FIG. 6 is a perspective view of part of the module of FIG. 5;

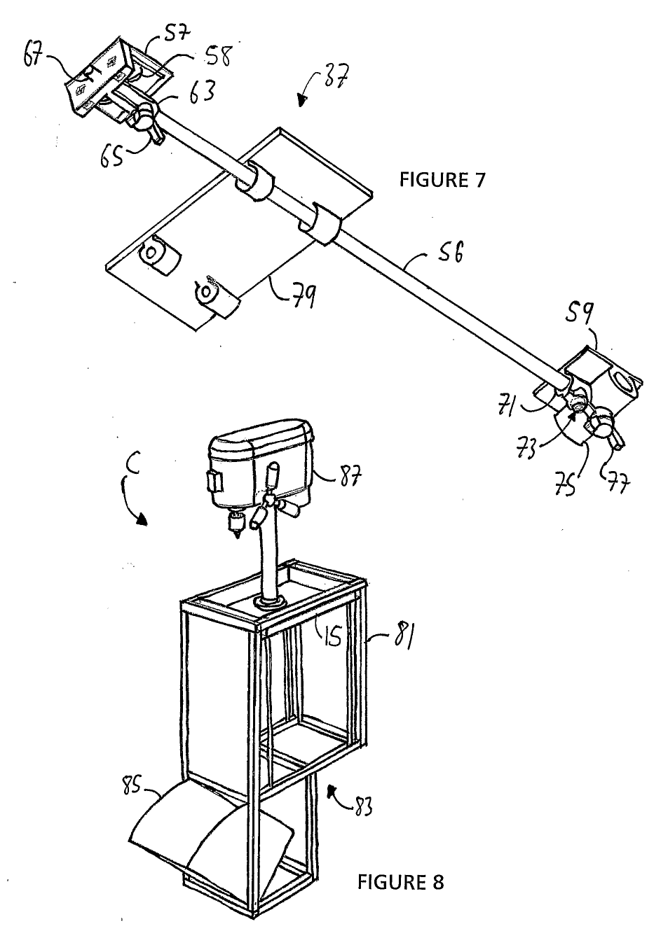

FIG. 7 is a perspective view of a mounting device comprising part of the work bench assembly of FIGS. 1 to 6;

FIG. 8 is a perspective view of a third module of the workbench assembly of FIGS. 1 and 2; and

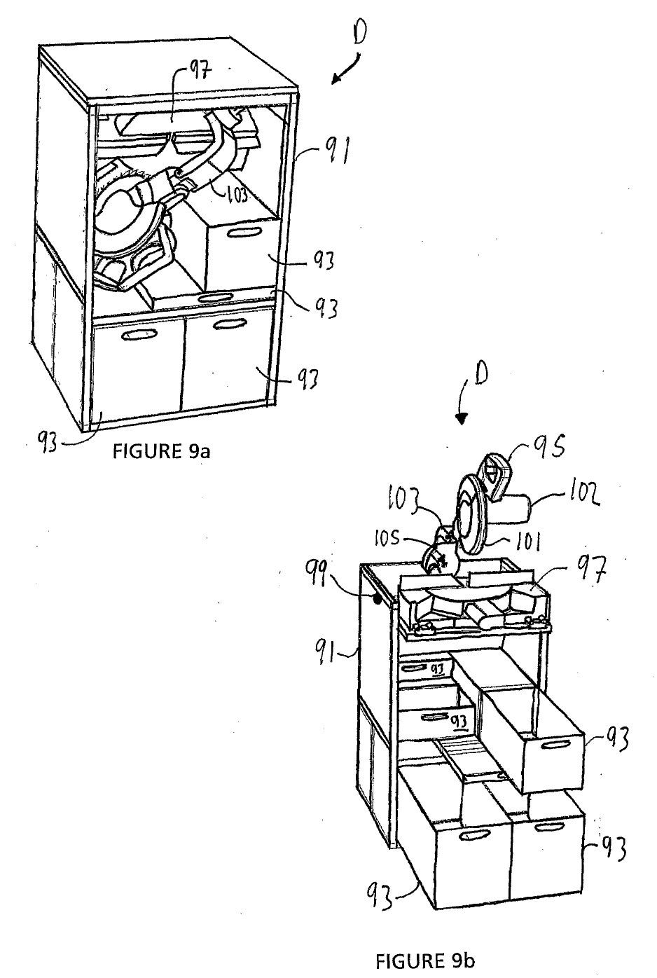

FIGS. 9 and 9b are perspective views from the front and one side of a fourth module of the work bench assembly of FIGS. 1 and 2, showing parts of the module in stored and operative positions respectively.

Referring initially to FIGS. 1 and 2, a modular work bench 1 comprises a plurality of releasably interconnectable bench modules A to D.

Each module A to D comprises a generally cuboidal framework and a planar work surface parallel to the base. When connected together the work surfaces of each module A to D form a composite, planar work surface extending along the length of the work bench 1.

Each module A to D is provided with retractable elements that are movable from a first, storage position as can be seen in FIG. 1, to a second, operative position as can be seen in FIG. 2.

It will be appreciated that the modular nature of the work bench means that not all modules need be used and indeed the operator can select which module or modules to initially purchase, and to subsequently use.

The first module A comprises a frame 3 so arranged that the lower, rear part of the frame 3 is recessed 5, the recess 5 enabling the module A to be mounted over a vehicle wheel arch (not shown).

A storage container 7 is tiltably mounted at the base of the frame 3. A drawer 9 is slidably mounted on the frame 3 above the tilting container 7.

The upper work surface 11 is removably mounted on top of the frame 3 using any suitable means which could include snap type connections. The underside of the work surface 11 may be spigoted, the spigot fitting inside the top of the frame 3 to resist the work surface 11 sliding from the frame 3.

A lathe 13 is mounted on mounting means comprising a carriage 15 itself mounted on the frame 3 beneath the upper work surface. The carriage 15 is mounted on vertical guide rails 17 attached to the frame 3 so as to be slidable vertically up and down within the frame 3, the weight of the carriage 15 being supported by hydraulic or gas struts 17.

In use, the work surface 11 is removed, and the carriage 15 is raised from the stored position of FIG. 1 to the operative position of FIG. 2 wherein the carriage 15 is co-planar with the work surfaces of the other modules B to D. A latch may be provided to latch the carriage 15 in the operative position, or the struts 17 may be lockable so that the length of the struts 17 is fixed when the carriage 15 is in the operative position.

A first part of the lathe 13 comprises a chuck 19 mounted on the carriage 15. A second part of the lathe 13 comprising another chuck 20 and a positional adjustment handles are mounted on a base 22 that is slidably and removably mounted on two parallel tracks 23 formed on the carriage 15. The distance between the lathe spindles 19, 20 can therefore be adjusted by sliding the base 22 along the tracks 23. In use, the tracks 23 line up with corresponding tracks 24 provided on the top of module B. A locking mechanism is provided to lock the base 22 in a desired position. The base 22, the second spindle 20 and the motor 21 are stored on the carriage 15 when the carriage 15 has been lowered to the stored position.

The forward margin of the top of the module A defines a channel 24 that extends along the length of module A. Pieces of equipment, or other sections of work surface can be hooked onto the channel 24. The other modules B to D are provided with similar channels.

Referring to FIGS. 5 and 6 the second module B comprises a frame 25 the lower, rear part of which is again recessed 26.

A planar rectangular retractable work table 27 is removably mounted on a support frame 28 that is itself pivotably mounted to the top front portion of the frame 25 so as to be able to pivot from An initial vertical position wherein the work table 27 is co planar with the front of the module B, to a horizontal position as can be seen in FIG. 3b. The support frame 28 is supported by lockable hydraulic or gas struts 29. The table 27 may pivot from an initially near vertical orientation wherein the plane of the table 27 is inclined to the vertical plane to enable sheet material to rest against the table 27.

The work table 27 comprises an oblong rigid periphery 31. A slide bar 33 is mounted adjacent one margin of the periphery 31, whilst the opposed margin comprises an elongate slot 35 extending along the length of the work table 27. The base of the slot 35 comprises a guide surface. The slide bar 33 and slot 35 comprise part of mounting means that enable various different pieces of equipment to be releasably mounted on the work platform 27 using quick release modular mounting devices 37. The mounting devices 37 are removably mountable on the slide bar 33 and slot 35 so as to extend transversely across the work table 27 in a direction perpendicular to the longitudinal axis of the slide bar 33 and slot 35.

A piece of electrical equipment, such as a circular saw for example, can be secured to a mounting plate 79 that is clamped or hooked onto the mounting devices 37.

The piece of equipment may comprise suitable integral fittings to enable the piece of equipment to be mounted directly on the slide bar 33 and slot 35.

In this example, a circular saw assembly 39 is mounted on a pair of mounting devices 37 that are themselves mounted directly on the slide bar 33 and slot 35. The saw assembly 39 comprises a motor mounted in an enclosure 43, the upper surface of which is provided with a slit 45 through which a circular saw blade 46 can be retracted and extended.

The saw assembly 39 can be moved along the work table 27 in a direction parallel to the longitudinal axis of the bar 33 and slot 35.

In this example a section of work surface 47 is also releasably mounted on the slide bar 33 and slot 35.

The second work bench module B is also provided with a retractable grinder 49 that is mounted on a retractable carriage 15 that can be raised and lowered along guide rails as described above with reference to Module A. The grinder 49 is positioned below a removable work surface formed on one side with longitudinal lathe tracks 24 as described above, and formed on the other side with transverse router tracks (not shown) for guiding material to be routed.

A router 51 is mounted on two mounting devices 37 that are themselves pivotably mounted 53 on the top of the frame 25 adjacent the retractable grinder 49. The mounting devices 37 can be pivoted out from the frame 25 from a position in which the router 51 is contained within the frame 25, to a pivoted position, as shown in FIG. 5, wherein the router 51 projects up from the top of the frame 25 and can be removed from the mounting device 37. The pivotal mounting 53 is itself slidably mounted on the frame 25 so that the when the router 51 is pivoted from the storage position, the pivotal mounting 53 is slid right to left when viewing FIG. 4 so that the mounting devices 37 are once again horizontal but with the router 51 projecting up from the top of the frame 25.

The router 51 is accessed from the side of module B by pivoting the work surface 47 away from module B. The router blade projects upwardly through a slot 54 formed in the top surface of module B.

The router 51 can be removed and mounted on work surface 47 for use on the work table 27.

Referring additionally to FIG. 6, the work table 27 is shown having been removed from the inner frame so as to be freestanding on telescopic legs 55.

Referring to FIG. 7, each mounting device 37 comprises a rod 56 the ends of which are received within a respective mounting bracket 57, 59.

The bracket 57 comprises an L shaped plate the underside of which is provided with a socket 63 which receives one end of the rod 56. A wing nut 65 is provided to clamp the end of the rod 56 within the socket 63. The exterior of the L shaped bracket is provided with a spring mounted retractable lug 67 that is received, in use, in the slot 35 on the work surface 27. The lug 67 can be retracted into the bracket 57 by pulling the lug against the force of the spring using finger apertures 58. This enables the mounting device 37 to be released from the slot 35. The bracket 57 functions as an end cap that can be removed to enable a mount 79, or a piece of equipment, to be slid onto the rod 56, the bracket 57 then being replaced on the end of the rod.

The bracket 59 comprises an oblong plate the underside of which is provided with a tubular socket 71 to receive the other end of the rod 56. A grub screw 73 is provided to clampingly engage the end of the rod 56 through the socket 71. A hollow tube 75 extends transversely across the bracket 69 and this receives the slide bar 33 of the work surface 27 in use. A wing nut 77 is provided to clamp the bracket 59 in a particular position on the slide bar 33.

A mounting plate 79 is slidably mounted on the rod 56 of each mounting device 37 and comprises securing means (not shown) to secure the desired piece of equipment to the plate 79. Alternatively the piece of equipment may comprise integral fixtures that enable the piece of equipment to be removably mounted directly on the rod 56 of each mounting device 37.

Referring to FIG. 8 the third module C comprises a frame 81 which again defines a recess 83 to enable the frame 81 to be mounted adjacent the wheel arch of a vehicle. A storage container 85 is tiltably mounted on the bottom of the frame 81.

A pillar drill 87 is mounted on a carriage 15 as described above with reference to module A and can thus be slid vertically from a storage position within the frame 81, to an operative position wherein the drill 87 projects from the top of the frame 81.

Referring to FIG. 9, the fourth module D comprises a cuboidal frame 91. A removable frame element 92 is mounted at the rear of the frame 91 to close off a wheel arch recess. This enables the recess to receive a deeper drawer or a tiltable tool box. A plurality of slidable drawers 93 are mounted on the frame 91 and are arranged to extend across the bottom region of the frame 91, and partially up one side region of the frame 91, the remainder of the interior of the frame 91 comprising a storage space for, in this example, a compound saw 95.

The compound saw 95 is secured to a chassis 97 that is mounted on a pair of mounting devices 37 that are themselves pivotably mounted 99 to the top of the frame 91, the pivot axis extending longitudinally along the top of the frame 91. The chassis 97 is slid onto the rods 56 of the mounting devices 37 and end caps 100 are then secured to the ends of the rods 56 to retain the saw 95 on the rods 56. The saw blade 101 and motor 102 are mounted on a composite adjustable arm 103. The lower end of the arm 103 is pivotably mounted 105 on the rear of the chassis 97 about a pivot axis that extends transversely from front to rear of the frame 91. This enables the saw blade 101 and arm 103 to be pivoted relative to the chassis 97 to enable the chassis 97 itself to be pivoted relative to the frame 91 so as to move between the storage and operative positions shown in FIGS. 9a and 9b respectively.

It will be appreciated that the various pieces of electrical equipment described above could be used with different modules as desired. Any other desired piece of equipment, whether electrical or otherwise, or any other item can be removably mounted on the modules A to D as desired and may include, for example, a vice, end stop or guide. The modules A to D themselves can be connected together in any formation or arrangement required. Not all of the modules A to D need be used. The composite guide channel that extends along the front of the work bench assembly can be used to hang equipment and tools, or to support one end of a removable work surface.

The modules A to D can be constructed from any suitable material or combination of materials which may include plastics materials.

The various work tops of each modules can be flipped over to reveal additional rails, apertures or slots for other pieces of equipment.

Different modules A to D could be mounted on opposed sides of a van with pivotable work surfaces being provided to pivot from a storage position to a horizontal position extending across the van from one module A to D to another.

A piece of equipment that could be mounted on one of the modules A to D is a removable sink unit which may be provided with an integral water tank and pump. A refrigerator could also be mounted on a retractable platform 15 of one of the modules A to D.

1. A work bench module, the module comprising a planar work surface, a storage space being defined in the module below the work surface, equipment mounting means being provided on which a piece of equipment can be mounted in use, the equipment mounting means being itself mounted on the module so as to be moveable from a retracted position in which the piece of equipment is stored in the storage cavity to an operative position in which the piece of equipment can be accessed from the exterior of the module.

2. The work bench module of claim 1 wherein the mounting means is slidably mounted on the module to enable the piece of equipment to slide from the retracted position to the operative position.

3. The work bench module of claim 2 wherein the mounting means comprises a carriage on which the piece of equipment is mounted in use, the carriage being movably mounted on at least one guide rail provided on the module.

4. The work bench module of claim 1 wherein the mounting means may be pivotally mounted on the module to enable the piece of equipment to pivot from the retracted position to the operative position.

5. The work bench module of claim 1 wherein the mounting means comprises support means to support the piece of equipment in the operative position.

6. The work bench module of claim 6 wherein the support means comprises a gas filled strut.

7. The work bench module of claim 6 wherein the gas filled strut is lockable so that, when locked, the length of the strut is non-adjustable.

8. The work bench module of claim 1 wherein the work bench module comprises a retractable work table movable from a retracted, substantially vertical position to an operative, substantially horizontal position.

9. The work bench module of claim 8 wherein the retractable work table is removably mounted on a support, the support being mounted on the work bench module, the work table, when removed from the support, being free standing.

10. The work bench module of claim 1 wherein the mounting means comprises means to enable the piece of equipment to be releasably mounted on the mounting means, and means to enable the mounting means to be releasably mounted on the work bench module.

11. The work bench module of claim 1 wherein the mounting means is adapted so as to be mounted on the work bench module to enable the piece of equipment to be moved relative to the work bench module when the piece of equipment is in the operative position.

12. The work bench module of claim 11 wherein the mounting means comprises a mounting device removably mounted on a bar on the work bench module such that a piece of equipment mounted on the device is movable in a direction along the bar.

13. The work bench module of claim 12 wherein part of the mounting device is mounted on the bar, another part being supported in use on an opposed guide surface on the work bench module.

14. The work bench module of claim 13 wherein the guide surface comprises part of a slot provided on the work bench module.

15. The work bench module of claim 13 wherein the mounting device comprises a rod that extends between the bar and the guide surface when the device is mounted on the work bench module, the piece of equipment being removably mounted on the device in use.

16. A work bench assembly comprising a plurality of work bench modules, at least one of the modules comprising a planar work surface, a storage space being defined in the module below the work surface, equipment mounting means being provided on which a piece of equipment can be mounted, the equipment mounting means being itself mounted on the module so as to be moveable from a retracted position in which the piece of equipment is stored in the storage space to an operative position in which the piece of equipment can be accessed from the exterior of the module.

17. A mounting device for removably mounting a piece of equipment on a work bench, the device comprising two spaced apart mounting brackets interconnected by a rod, the brackets comprising formations that engage, in use, with part of a workbench so as to removably mount the device on the work bench, and a mount being movably mounted on the rod for movement along the rod, the piece of equipment in use being mounted on the mount.

18. (canceled)

19. The mounting device of claim 17 wherein at least one of the brackets comprises a pivot operative such that the rod can pivot relative to the work bench in use.
